(19) United States
(12) Patent Application Publication
(10) Pub. No.: US 2022/0065307 A1
(43) Pub. Date: Mar. 3, 2022

(54) ALUMINUM PRESSURE PLATE ASSEMBLY FOR ALL-TERRAIN VEHICLES

(71) Applicant: Richard Mellick Zock, Lapeer, MI (US)

(72) Inventor: Richard Mellick Zock, Lapeer, MI (US)

(21) Appl. No.: 17/305,062

(22) Filed: Jun. 30, 2021

Related U.S. Application Data
(60) Provisional application No. 62/706,582, filed on Aug. 26, 2020.

(51) Int. Cl. F16D 13/70

(52) U.S. Cl. CPC F16D 13/70

(57) ABSTRACT

A pressure plate assembly for an all-terrain vehicle clutch assembly, wherein the pressure plate assembly provides a billet aluminum pressure plate and upgraded hardened screws adapted for 1987-2003 WARRIOR 350, 1987-1997 BIG BEAR 350, 1993-1998 KODIAK 400, 2004-2013 RAPTOR 350 vehicles as well as other machines.

### CROSS-REFERENCE TO RELATED APPLICATION

This application claims the benefit of priority of U.S. provisional application No. 62/706,582, filed 26 Aug. 2020, the contents of which are herein incorporated by reference.

### BACKGROUND OF THE INVENTION

The present invention relates to pressure plates for all-terrain vehicles and, more particularly, a pressure plate assembly including a billet aluminum pressure plate and upgraded hardened screws adapted for 1987-2003 WARRIOR 350, 1987-1997 BIG BEAR 350, 1993-1998 KODIAK 400, 2004-2013 RAPTOR 350 vehicles as well as other machines.

A standard clutch assembly comprises of several different parts that fit together and assist in helping you to change gear and pull away smoothly. These are the clutch cover, clutch plate, pressure plate, clutch fork, clutch cable or hydraulic system and bearing.

Existing pressure plates use cast aluminum, a material that can be easily broken or damaged. Which is problematic as undetected damage, stress fractures, weakness, or other points of failure in pressure plates can lead to inoperability of the machine if not catastrophic failure. Furthermore, cast aluminum wears out quicker and is not cheap to replace.

As can be seen, there is a need for a pressure plate assembly for all-terrain vehicles, wherein the pressure plate assembly includes a billet aluminum pressure plate and upgraded hardened screws adapted for 1987-2003 WARRIOR 350, 1987-1997 BIG BEAR 350, 1993-1998 KODIAK 400, 2004-2013 RAPTOR 350 vehicles as well as other machines. Solid billet aluminum material is stronger, more durable, and can withstand much more abuse than cast aluminum. Furthermore, billet aluminum costs half as much as cast aluminum. As a result, the present invention is more durable and more affordable than the prior art.

### SUMMARY OF THE INVENTION

In one aspect of the present invention, an all-terrain clutch assembly, the assembly comprising a billet aluminum pressure plate and a plurality of hardened fasteners.

In another aspect of the present invention, the all-terrain clutch assembly includes a plurality of post, each post having a threaded bore engaging one of the plurality of hardened fasteners, wherein the plurality of hardened fasteners are grade 12.9 bolts.

In yet another aspect of the present invention, a method of improving a pre-existing all-terrain clutch assembly, the method including replacing a pre-existing pressure plate of the pre-existing all-terrain clutch assembly with the billet aluminum pressure plate of the above-mentioned assembly; and fastening the billet aluminum pressure plate with the plurality of hardened fasteners.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention; and

FIG. 2 is an exploded perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, the present invention provides a pressure plate assembly for an all-terrain vehicle clutch assembly, wherein the pressure plate assembly provides a billet aluminum pressure plate and upgraded hardened screws adapted for 1987-2003 WARRIOR 350, 1987-1997 BIG BEAR 350, 1993-1998 KODIAK 400, 2004-2013 RAPTOR 350 vehicles as well as other machines.

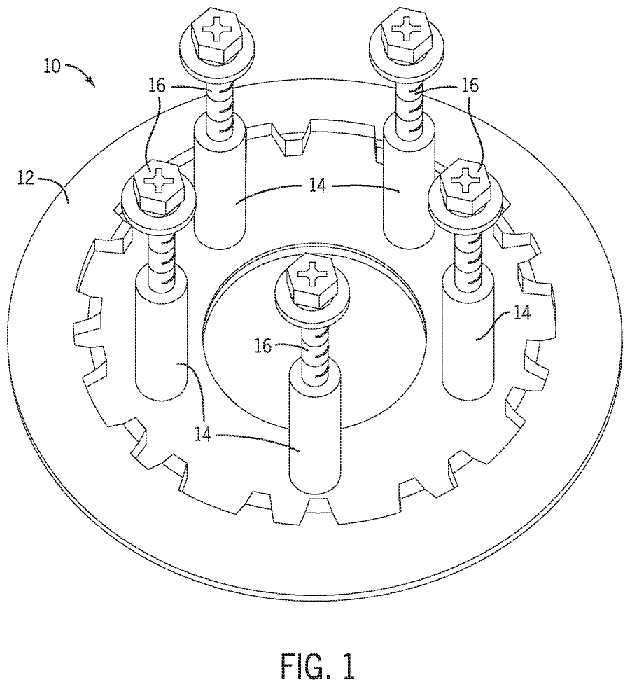

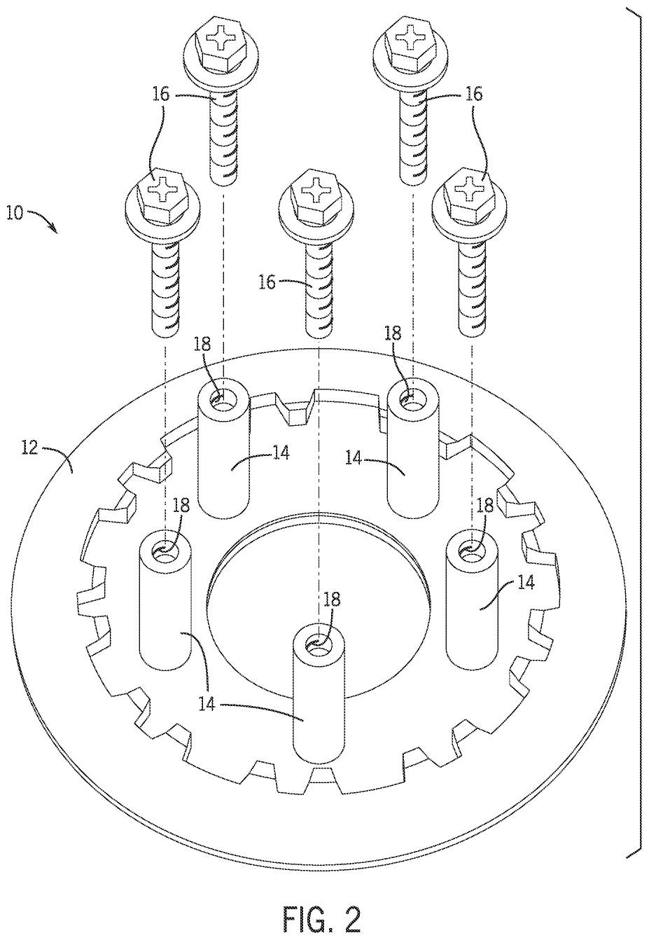

Referring now to FIGS. 1 and 2, the present invention may include a pressure plate assembly 10. The pressure plate assembly 10 may include a hardened pressure plate 12 a plurality of hardened fasteners 16 that operatively associate with the billet aluminum pressure plate 12. It being understood that the pressure plate 12 may be made of billet aluminum but is not necessarily limited to billet aluminum, as other equivalent hardened materials may suffice as long as they lend themselves to the advantages disclosed herein.

The pressure plate 12 may provide posts 14 or dowels dimensioned and adapted to engage the hardened fasteners 16, wherein each post 14 may have threaded bores 18 that provide complementary threading for engaging one of the hardened fasteners 16.

Specifically, the plurality of hardened fastener may include grade 12.9 threaded bolts or other fasteners dimensioned and adapted to engage the threaded bores 18 and made from a material hardened so as to lend itself to the advantages disclosed herein. There may be other M6X1 bolts, washers, and/or screws used to hold the overall assembly together.

A method of using the present invention may include the following. The pressure plate assembly 10 disclosed above may be provided. A user may remove a portion of the case of the engine of the all-terrain vehicle where the clutch housing would be placed, uninstall the clutch basket, and unbolt the basket where the clutch plates and metal plates are seated. After removing the clutch plates with the metal plates in one piece, the user would install the pressure plate 12 and secure them to the correct torque with the hardened fasteners 16 provided as part of the assembly and or kit. Then the user would install the overall assembly back into the motor, placing a new gasket on the side, place a new cover back on and fastening the side cover screws. It is understood that the clutch plate needs to be inserted onto the crankshaft on the engine, wherein the clutch plates are inserted into the clutch basket in a certain orientation. The basket is then inserted in place with the plate covering the other half. The hardened fasteners 16 are then used to fasten all the components together as an assembly. The user would then put the correct type of oil back in the motor.

It should be understood, of course, that the foregoing relates to exemplary embodiments of the invention and that modifications may be made without departing from the spirit and scope of the invention as set forth in the following claims.

What is claimed is:

1. An all-terrain clutch assembly, the assembly comprising a billet aluminum pressure plate and a plurality of hardened fasteners.

2. The assembly of claim 1, wherein the billet aluminum pressure plate comprises a plurality of post, each post having a threaded bore engaging one of the plurality of hardened fasteners.

3. The assembly of claim 2, wherein the plurality of hardened fasteners are grade 12.9 bolts.

4. A method of improving a pre-existing all-terrain clutch assembly, the method comprising:
replacing a pre-existing pressure plate of the pre-existing all-terrain clutch assembly with the billet aluminum pressure plate of the assembly of claim 3; and
fastening the billet aluminum pressure plate with the plurality of hardened fasteners.
